(19) United States
(12) Patent Application Publication
(10) Pub. No.: US 2007/0064714 A1
(43) Pub. Date: Mar. 22, 2007

(54) Wireless based troubleshooting of customer premise equipment installation

(75) Inventors: Haifeng Bi, San Antonio, TX (US); Albert Wilhelm, Austin, TX (US); Tracy Zavelson, Austin, TX (US); Mark Roche, Austin, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/227,193

(22) Filed: Sep. 16, 2005

(51) Int. Cl. H04L 12/56

(52) U.S. Cl. 370/401

(57) ABSTRACT

Troubleshooting of customer premise equipment installation includes receiving a request for troubleshooting information over a wireless link. The troubleshooting also includes providing information relating to an attempt to activate the customer premise equipment over the wireless link in response to receiving the request for troubleshooting information over the wireless link.

### BACKGROUND OF THE INVENTION

1. Field of the Invention

The present invention relates to customer premise equipment (CPE) installation. More particularly, the present invention relates to wireless based troubleshooting of CPE installation.

2. Background Information

Currently, to activate voice over internet protocol (VoIP) service, an installer is typically required to install special-purpose VoIP CPE. The VoIP CPE may be an analog terminal adapter (ATA), an internet protocol (IP) phone or another internet protocol telephony device. The installation of the VoIP CPE can be performed by the end user or a technician of the VoIP service provider.

Before VoIP CPE is ready for its first use, it must be installed and properly provisioned. The CPE must first communicate with a file server in the service provider's network and request a configuration file which contains operation instructions. Then the CPE must register with a registration server in the service provider's network. Only when these steps are successfully completed will the CPE be able to provide the installer with a dial tone. If anything goes wrong with this process, the installation will fail, and the installer will not be able to start using the VoIP service.

Currently, if the CPE installation fails, the installer may receive certain visual or audible indications of the failure. For example, failure may be indicated by a light on the CPE that is either dim or lit in a color that indicates a problem. Alternatively, the installer may not be able to detect a dial tone. While these indicators indicate that the installation has failed, they do not give more detailed information about the error, e.g., whether the problem is with the file server or the registration server.

With most VoIP CPE, the detailed information about the error is present on the CPE. To retrieve the error information, a computer needs to be connected to the CPE directly or via a wired network. However, a VoIP service provider's technician is often not equipped with a notebook personal computer, and many CPE end users do not have a personal computer. Therefore, it is not always possible to retrieve the error information with a computer directly or via a wired network during the CPE installation.

Accordingly, a need exists for wireless based troubleshooting of customer premise equipment installation. To solve the above-described problems, wireless based troubleshooting of customer premise equipment installation is provided.

### BRIEF DESCRIPTION OF THE DRAWINGS

FIG. 1 shows an exemplary general computer system that includes a set of instructions for performing wireless based troubleshooting of customer premise equipment installation;

FIG. 2 shows an exemplary method for wireless based troubleshooting of customer premise equipment installation;

FIG. 3 shows an exemplary setup of customer premise equipment that is connected to a network;

FIG. 4 shows exemplary customer premise equipment by which wireless based troubleshooting of customer premise equipment installation can be provided;

FIG. 5 shows an exemplary wireless device by which wireless based troubleshooting of customer premise equipment installation can be provided; and

FIG. 6 shows an exemplary method of operation of the wireless device shown in FIG. 5.

### DETAILED DESCRIPTION

In view of the foregoing, the present invention, through one or more of its various aspects, embodiments and/or specific features or sub-components, is thus intended to bring out one or more of the advantages as specifically noted below.

According to an aspect of the present invention, a method for installing customer premise equipment is provided. The method includes receiving over a wireless link, at customer premise equipment, a request for troubleshooting information. The method also includes providing information relating to an attempt to activate the customer premise equipment over the wireless link in response to receiving the request for troubleshooting information over the wireless link.

According to another aspect of the present invention, the customer premise equipment is voice over internet protocol customer premise equipment.

According to still another aspect of the present invention, the voice over internet protocol customer premise equipment is one of an analog terminal adapter, an internet protocol phone, an integrated access device and a residential gateway.

According to yet another aspect of the present invention, the wireless link conforms to at least one of an 802.11x, a wireless fidelity, a Bluetooth and an infrared, wireless local area networking protocol.

According to another aspect of the present invention, the information includes error information corresponding to a reason an attempt to activate the customer premise equipment has failed.

According to an aspect of the present invention, a computer readable medium is provided for storing a computer program that provides information for installing customer premise equipment. The computer readable medium includes a request receiving code segment that receives over a wireless link, at customer premise equipment, a request for troubleshooting information. The computer readable medium also includes an information providing code segment that provides information relating to an attempt to activate the customer premise equipment over the wireless link in response to receiving the request for troubleshooting information over the wireless link.

According to another aspect of the present invention, the customer premise equipment is voice over internet protocol customer premise equipment.

According to still another aspect of the present invention, the voice over internet protocol customer premise equipment is one of an analog terminal adapter, an internet protocol phone, an integrated access device and a residential gateway.

According to yet another aspect of the present invention, the wireless link conforms to at least one of an 802.11x, a wireless fidelity, a Bluetooth and an infrared, wireless local area networking protocol.

According to another aspect of the present invention, the information includes error information corresponding to a reason an attempt to active the customer premise equipment has failed.

According to an aspect of the present invention, customer premise equipment is provided. The customer premise equipment includes a transmitter that sends information over a communications network to attempt to activate the customer premise equipment. The customer premise equipment also includes a wireless receiver that receives over a wireless link a request for troubleshooting information. The customer premise equipment further includes a wireless transmitter that transmits information relating to the attempt to activate the customer premise equipment over the wireless link in response to receiving the request for troubleshooting information over the wireless link.

According to another aspect of the present invention, the customer premise equipment is voice over internet protocol customer premise equipment.

According to yet another aspect of the present invention, the voice over internet protocol customer premise equipment is one of an analog terminal adapter, an internet protocol phone, an integrated access device and a residential gateway.

According to still another aspect of the present invention, the wireless link conforms to at least one of an 802.11x, a wireless fidelity, a Bluetooth and an infrared, wireless local area networking protocol.

According to another aspect of the present invention, the information includes error information corresponding to a reason the attempt to activate the customer premise equipment has failed.

According to an aspect of the present invention, a wireless apparatus is provided. The wireless apparatus includes a wireless transmitter that sends over a wireless link, to customer premise equipment, a request for troubleshooting information, the troubleshooting information relating to an attempt to activate the customer premise equipment. The wireless apparatus also includes a wireless receiver that receives the troubleshooting information over the wireless link.

According to another aspect of the present invention, the customer premise equipment is voice over internet protocol customer premise equipment.

According to still another aspect of the present invention, the voice over internet protocol customer premise equipment is one of an analog terminal adapter, an internet protocol phone, an integrated access device and a residential gateway.

According to yet another aspect of the present invention, the wireless link conforms to at least one of an 802.11x, a wireless fidelity, a Bluetooth and an infrared, wireless local area networking protocol.

According to another aspect of the present invention, the information includes error information corresponding to a reason the attempt to activate the customer premise equipment has failed.

The present invention enables a person installing and/or configuring CPE to troubleshoot installation problems using the CPE and a wireless device. In particular, the present invention enables a person to troubleshoot installation and/or configuration problems when installing and/or configuring VoIP CPE such as a VoIP phone or an analog terminal adapter and analog telephone. The installation of the VoIP CPE can be performed by the end user or a technician of the VoIP service provider.

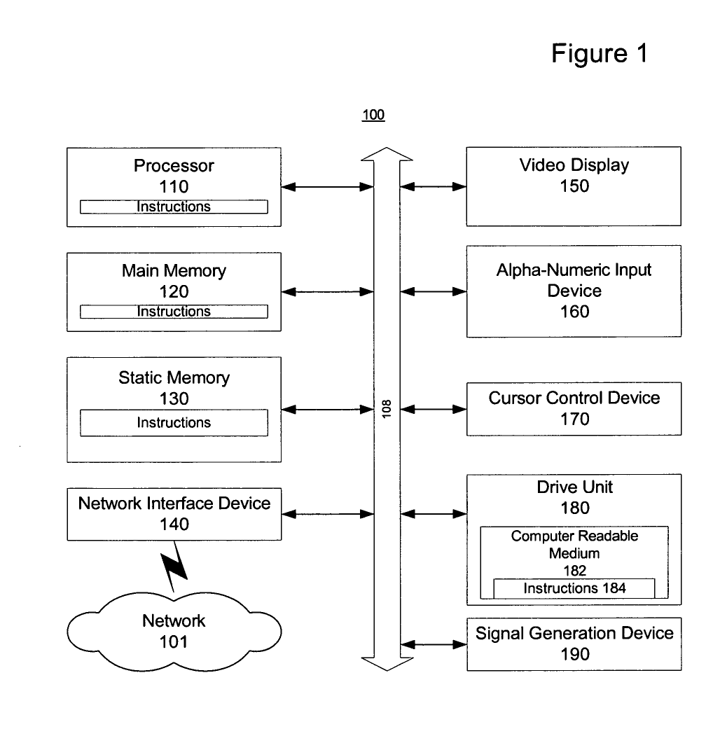

Referring to FIG. 1, an illustrative embodiment of a general computer system, on which wireless based troubleshooting of customer premise equipment installation can be implemented, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, an internet protocol (IP telephone), an analog terminal adapter (ATA), a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

An installer can attempt to install, configure and/or activate VoIP CPE which includes a general computer system as shown in FIG. 1. When the VoIP CPE is not successfully activated, information relating to the reason(s) the attempt has failed can be provided to a portable or hand-held wireless device over a wireless link.

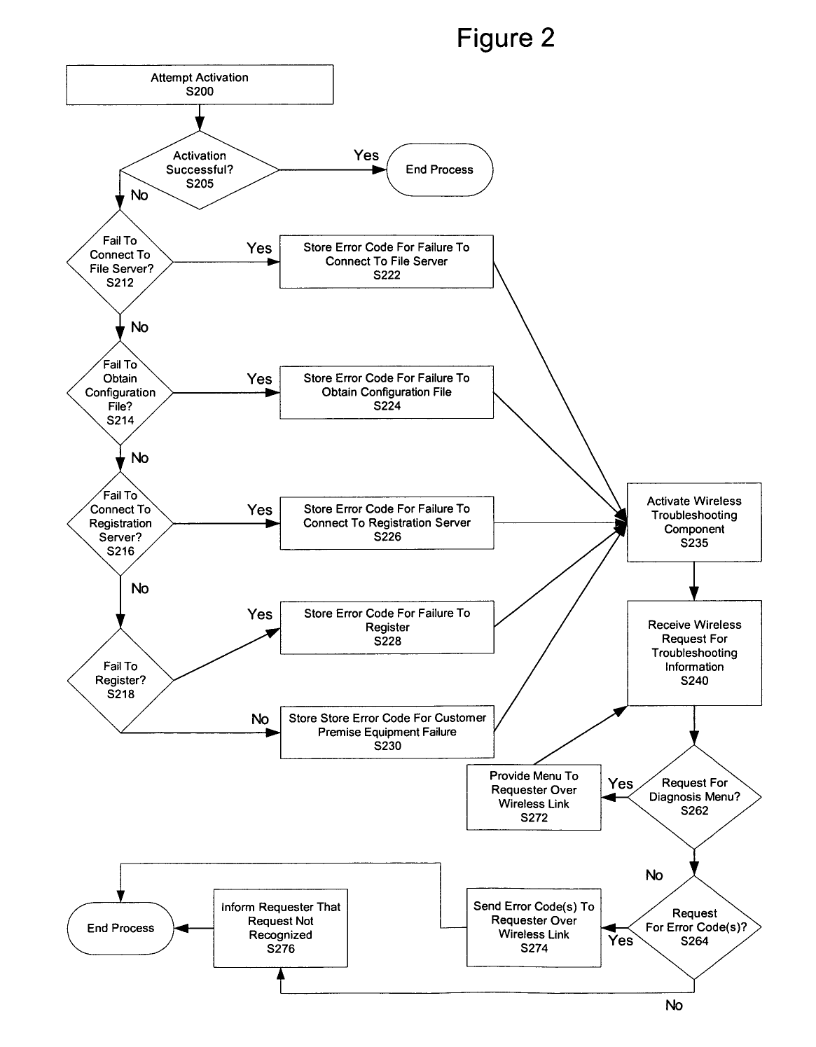

FIG. 2 shows an exemplary method for wireless based troubleshooting of customer premise equipment installation. The process starts when an attempt is made to activate CPE at S200. A determination is made at S205 whether the activation attempt is successful. If the activation attempt is successful (S205=Yes), the process ends.

If the activation attempt is unsuccessful (S205=No), one or more determinations are made as to the cause of the failure. The causes determined to be attributable to the failure may be related to information provided from network servers, or may be based on simple determinations that a particular process or action has not successfully completed.

At S212, a determination is made whether there was a failure to connect to a file server. If there was a failure to connect to a file server (S212=Yes), an error code for the failure to connect to the file server is stored at S222. If there was no failure to connect to a file server (S212=No), a determination is made at S214 whether there was a failure to obtain a configuration file. If there was a failure to obtain a configuration file (S214=Yes), an error code for the failure to obtain a configuration file is stored at S224. If there was no failure to obtain a configuration file (S214=No), a determination is made at S216 whether there was a failure to connect to a registration server. If there was a failure to connect to a registration server (S216=Yes), an error code for the failure to connect to a registration server is stored at S226. If there was no failure to connect to a registration server (S216=No), a determination is made at S218 whether there was a failure to register. If there was a failure to register (S218=Yes), an error code for the failure to register is stored at S228. If there was no failure to register (S218=No), an error code for CPE failure is stored at S230.

It should be noted that the determinations at S212, S214, S216 and S218, and the error codes that are stored at S222, S224, S226, S228 and S230, are exemplary and non-limiting. Failures related to activation attempts may be due to numerous reasons in addition to the exemplary reasons listed herein, and additional determinations of cause are contemplated within the scope of the present invention.

Additionally, the process is not limited to identifying only a single cause for a failure to activate CPE. Rather, in another embodiment, after an error code is stored at S222, S224, 226, 228 S230, the process may loop back to a subsequent determination at S212, S214, S216 and/or S218 to determine whether additional errors have occurred.

After an error code is stored at S222, S224, S226, S228 or S230, the process waits for the installer to activate a wireless troubleshooting component at S235. The wireless troubleshooting component may be activated when the installer, e.g., presses a button or turns a switch or dial. Whereas much wireless equipment emits a wireless signal during normal operation, an activation button, switch or dial may be useful if the wireless troubleshooting component of the CPE is the only functionality, or one of a few limited functions, of the CPE that uses a wireless link. Accordingly, the wireless troubleshooting component may be turned off during normal operation of the CPE and turned on only when problems occur during the installation or operation of the CPE.

In another embodiment, the interactive voice response based troubleshooting component is initially activated, without use of a button or tactile input device, when an installer picks up a telephony device connected to the CPE and inputs a predetermined sequence of digits on a keypad. The installer may be prompted, e.g., automatically the first time the CPE detects that an off-hook signal, to provide input to retrieve troubleshooting information. Alternatively, the installer may be prompted through an interactive menu only if the installer enters a predetermined access code. An exemplary announcement could be “Welcome to the installation troubleshooting menu, please press 123 to access the diagnostics menu, please press 456 for a listing of recent error codes”. In these examples, the CPE would passively monitor off-hook and input DTMF signals, and determine when the interactive voice response based troubleshooting component is being invoked.

After the wireless troubleshooting component is activated at S235, the process waits to receive a wireless request for troubleshooting information at S240. The request for troubleshooting information at S240 occurs when a person trying to install the CPE uses a wireless device to retrieve information from the CPE. Troubleshooting information is information relating to the inability to successfully activate the CPE. Troubleshooting information may include both information relating to the nature and source of the problems, as well as information relating to solutions to the problems.

The wireless device may be any device that can communicate with the CPE over a wireless interface. For example, the wireless device may be a portable or hand-held wireless device, such as a notebook personal computer, a personal digital assistant (PDA) or a smart phone.

The CPE and the wireless device use a wireless interface to communicate. For example, the devices may communicate according to 802.11x protocols (such as 802.11a, 802.11b, 802.11g), a Wireless Fidelity (Wi-Fi) protocol, Bluetooth protocols or Infrared protocols.

The CPE can be either a telephony device (e.g., an internet protocol telephone) or a peripheral (e.g., an analog terminal adapter) connected via a wire to a telephony device. As a telephony device or peripheral, the CPE is configured to enable communication over a (first) long-range telephony network. As an example, the analog terminal adapter enables an analog telephone to communicate using VoIP over a digital broadband network such as a digital subscriber line (DSL) or cable network. A digital broadband network can be used as a telephony network using protocols such as VoIP.

The CPE is also configured to communicate over a (second) local area wireless network. Troubleshooting is performed over a local short-range wireless network using a wireless interface such as those noted above. Accordingly, while CPE may be configured for primary use over the long-range digital broadband network, CPE installation troubleshooting may be performed using a short-range wireless link. As explained herein, error information can be obtained by the CPE installer using the second local area wireless network link, so as to enable the CPE installer to configure and install the CPE on the first digital broadband network.

The CPE can be designed to provide the error information in any manner compatible with the wireless device. For example, the CPE can be designed to return data that “CPE failed to connect to file server”, “CPE failed to obtain configuration file”, “CPE failed to connect to registration server”, and “CPE failed to register”.

In response to the request for troubleshooting information at S240, the wireless troubleshooting component may present the installer with a list of available information. Alternatively, the installer may be expected to possess prior knowledge of which requests for information are accepted, so as to limit use of the troubleshooting component of the CPE. The CPE may also be configured to provide information related to any other error that is anticipated to potentially cause failure in an attempt to install the CPE.

The data from the CPE may be returned in any text or markup language format. For example, the data from the CPE may be returned and presented to the installer on the wireless device as hyper text markup language (HTML) or an appropriate type of extensible markup language (XML).

In another embodiment, instead of providing information for only the errors, a complete list of events including both errors and successes can be provided, such that the installing person not only knows when there are errors, but can also confirm when certain processes were successfully completed. In other embodiments, multiple lists can be supported, such as a complete event list and an error-event list, with the latter being a subset of the former.

In another embodiment, instead of providing a fixed number of events, the events can be qualified by time. For example, the list of events provided by default can be the most recent events that occurred within the past twenty four hours. In still another embodiment, the events can be qualified by both number and time. For example, the list of events may be limited to up to the five most recent events that occurred within the past twenty four hours. The number of events and the time qualifier may be pre-configured on the CPE in the factory, and may be modified at a later date.

The request for information is analyzed at S262 to determine whether the request is for a diagnosis menu. If the request is for a diagnosis menu (S262=Yes), the diagnosis menu is provided over the wireless link at S272, and the process loops back to S240 where another request for information is received.

If the request is not for a diagnosis menu (S262=No), a determination is made at S264 whether the request is for error codes. If the request is for error codes (S264=Yes), the error codes are provided over the wireless link at S274 and the process ends. If the request is not for error codes (S264=No), information is sent to the requester at S276 that the request is not recognized, and the process ends.

As described above, according to the embodiment shown in FIG. 2, the wireless based troubleshooting component of the CPE equipment provides data to a wireless device over a wireless link in response to an installer's request for information.

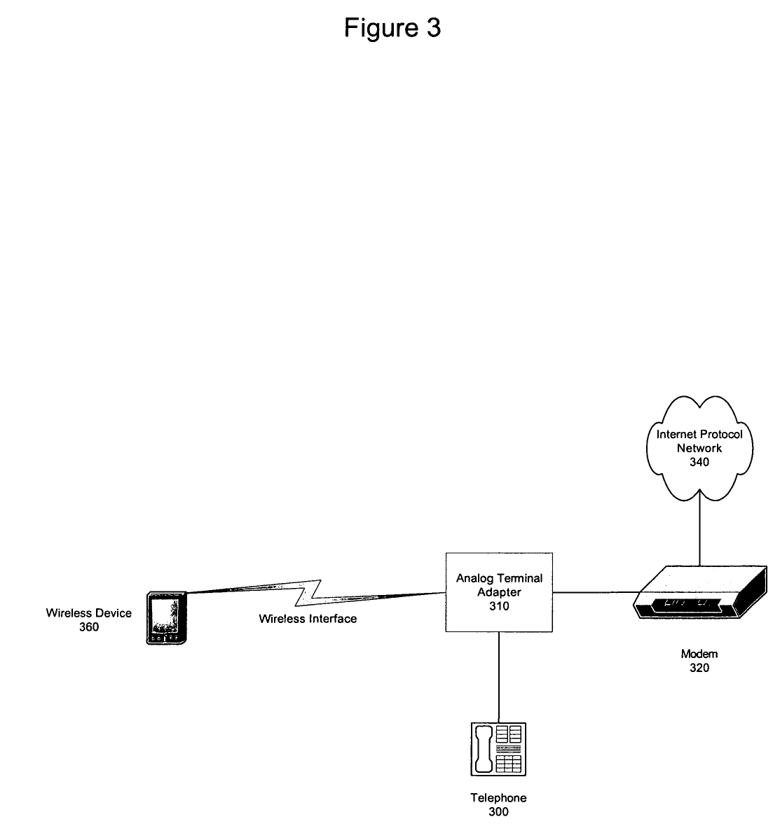

FIG. 3 shows an exemplary setup of CPE that is connected to a network. In the embodiment shown in FIG. 3, an analog telephone 300 is connected to an analog terminal adapter 310. The analog terminal adapter 310 is connected to a network 340 through a modem 320.

The analog terminal adapter 310 supports a troubleshooting system which is managed through the wireless device. An installer connects the phone 300 to the analog terminal adapter 310, and connects the analog terminal adapter to the modem 320. In an initial period, the analog terminal adapter 320 powers up and attempts to configure itself and register over the internet protocol network 340. When the analog terminal adapter 310 is not properly activated, the installer uses the wireless device 360 to “find” a wireless signal from the analog terminal adapter 310. The installer uses the wireless device 360 to retrieve error information from the analog terminal adapter 310. The installer may use a menu based system to find and retrieve the error information, or may make direct requests using predetermined request codes. The installer may request a diagnosis menu and/or error codes at S40, and the request is recognized at S262 or S264.

According to the embodiments described above, when the installer suspects that the CPE installation has failed, the installer can obtain the reasons for failure by performing only a few simple actions. In an embodiment, where the CPE is an analog terminal adapter, the installer turns on the wireless device, “finds” a signal from the CPE, and requests the diagnosis information over the wireless link.

In response to the request, the installer may retrieve error information, followed by a timestamp, for example “Monday, Ten Thirty Eight AM”. This message would indicate the reason for the failure to activate the CPE. For example, the message may indicate that the installation failed, not because of an error connecting to the file server, or an error obtaining a configuration file, or an error connecting to the registration server, but because the registration server rejected this CPE. In this example, the CPE may not have been properly provisioned on the VoIP network, or may be blocked from service for other reasons determined by the service provider. Based on this, the installer could call the back office to verify the service status instead of trying out another piece of CPE.

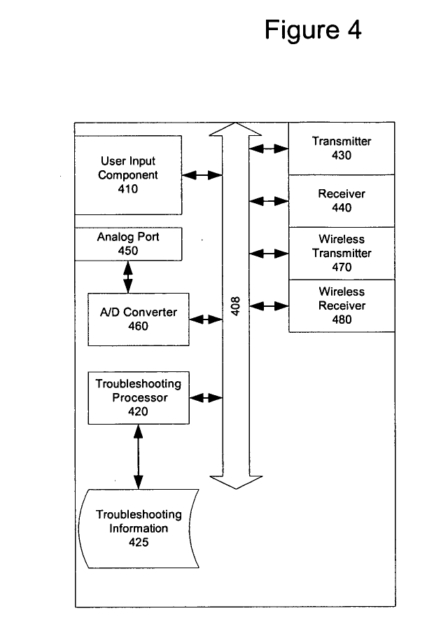

FIG. 4 shows exemplary CPE by which wireless based troubleshooting of customer premise equipment installation can be provided. Only a few exemplary components of the CPE are shown in FIG. 4. However, the CPE may contain additional components such as the various components of a general computer system shown in FIG. 1.

In the embodiment shown in FIG. 4, the exemplary CPE is an analog terminal adapter. An analog port 450 interfaces with an analog jack from an analog telephone, and analog input from the analog telephone is converted to digital signals by an analog-to-digital (A/D) converter 460. The A/D converter communicates with other components of the CPE over a system bus 408. The CPE shown in FIG. 4 also includes a transmitter 430 and a receiver 440 for communicating over a VoIP network. Accordingly, the analog terminal adapter shown in FIG. 4 can be used to interface an analog telephone to an internet protocol network.

The exemplary CPE in FIG. 4 includes a user input component 410. The user input component 410 may be a button, switch or dial that is used to activate the CPE. Once pushed or turned, the wireless troubleshooting component of the CPE is activated, and the stored error information is made available to a wireless device 360 over a wireless link.

The CPE in FIG. 4 includes a wireless transmitter 470 and a wireless receiver 480. The wireless transmitter 470 and wireless receiver 480 may be used to communicate with the wireless device 360 according to a common, compatible wireless protocol. The wireless receiver 480 receives wireless requests from the wireless device 360.

When an installer suspects that the CPE installation has failed, the installer can initiate a download of the diagnostic information from the CPE to the wireless device 360 without needing to connect the CPE and the hand-held device by a piece of wire. The installer can review the downloaded information on the wireless device, and perform troubleshooting using the diagnostic information.

The CPE in FIG. 4 includes a troubleshooting processor 420 and troubleshooting information 425. The troubleshooting processor 420 recognizes when errors occur during activation attempts, and ensures that error information is stored as troubleshooting information 425 for later use. The troubleshooting processor 420 also receives the requests for error information from the installer. The troubleshooting processor 420 executes a program that responds to the requests by providing the installer with, e.g., a diagnosis menu at S272 or specific error information at S274.

Accordingly, by activating a wireless based troubleshooting component of the CPE, an installer is able to receive detailed information relating to a failed attempt to activate the CPE. The installer is able to receive the detailed information without requiring that a computer be connected to the CPE either directly or via a wired network. Further, the wireless troubleshooting component may be provided only for limited purposes including troubleshooting, such that it can be deactivated during normal use of the CPE. The detailed information is made available without requiring a personal computer, and without requiring a working connection to the network. In fact, as explained herein, the wireless based troubleshooting component of the CPE assists a user in obtaining a working connection to a network where no working connection yet exists.

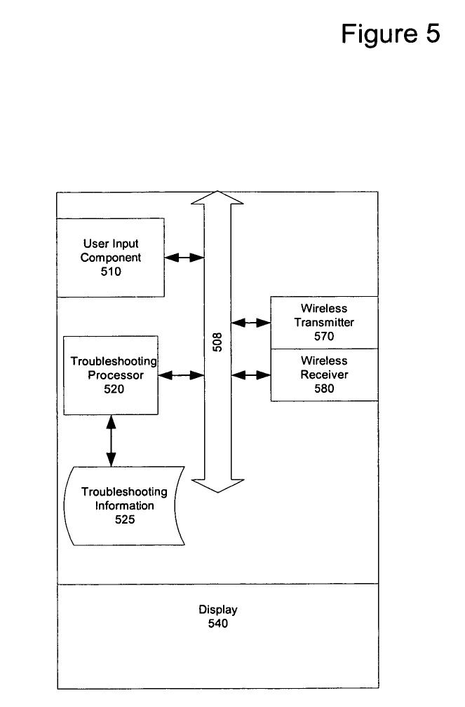

FIG. 5 shows an exemplary wireless device by which wireless based troubleshooting of customer premise equipment installation can be provided. As shown the wireless device includes a user input component 510, such as a power switch which can be used to turn the wireless troubleshooting component of the CPE on. The wireless device also includes a display 540, by which an installer may view information used in troubleshooting CPE installation.

The wireless device also includes a wireless transmitter 570 and a wireless receiver 580, which are used in communications with the CPE over a wireless link. A troubleshooting processor 520 executes instructions for a troubleshooting program used by the installer. The instructions may be stored as troubleshooting information 525.

The wireless device may be a general purpose wireless device such as a PDA or laptop, with a program installed for troubleshooting CPE installation. The program may include a list of common errors that occur during CPE installation, as well as the steps that need to be taken to resolve the errors. Accordingly, when the installer uses the wireless device shown in FIG. 5 to troubleshoot CPE installation, the installer can view error information for errors that actually occurred, as well as solution information for any error that has occurred, on the display 540.

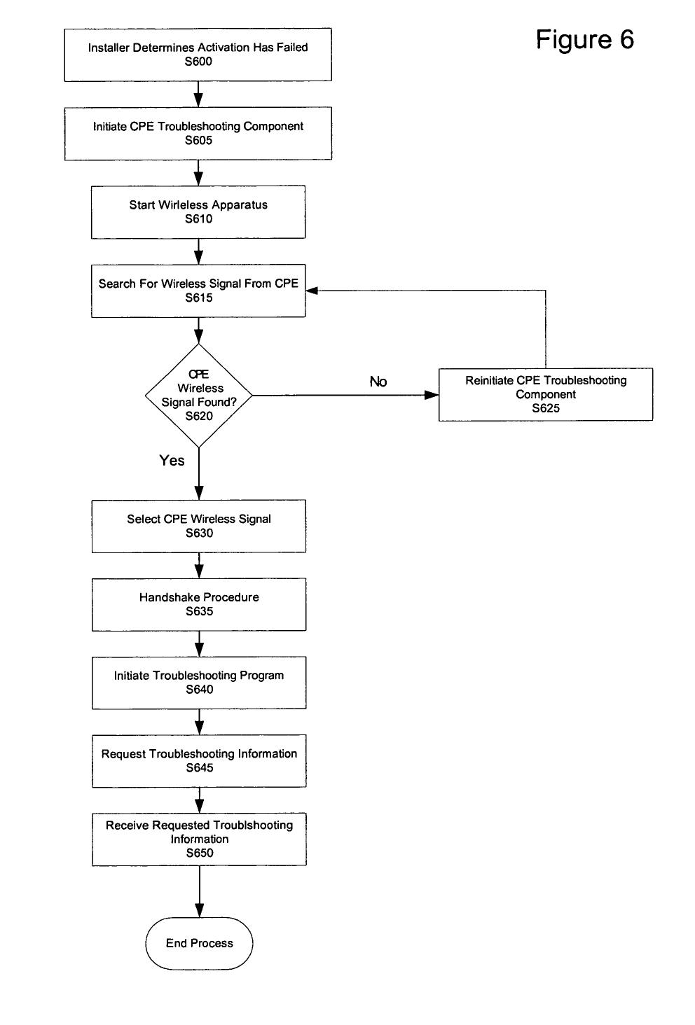

FIG. 6 shows an exemplary method of operation of the wireless device shown in FIG. 5. At S600, the installer determines that activation of the CPE has failed. At S605, the installer initiates a troubleshooting component on the CPE by, e.g., pressing a button, or turning a knob or switch on the CPE. In this regard, if the wireless functionality on the CPE is provided only for limited purposes such as troubleshooting CPE installation, the wireless functionality may be turned off during normal operation of the CPE and turned on only when problems occur during the installation or operation of the CPE.

The installer starts the wireless apparatus at S610. The installer uses the wireless device to search for a signal from the CPE. The wireless apparatus searches for the wireless signal from the CPE at S615. A determination is made at S620 whether the CPE's wireless signal is found. If the CPE wireless signal is not found (S620=No), the installer re-initiates the CPE troubleshooting component at S625 by, e.g., pressing a button or turning a knob or switch on the CPE, and the process returns to S615 to search for a wireless signal from the CPE.

Where numerous wireless signals are found, the installer may select the CPE signal to begin communicating with the CPE. Therefore, if the CPE wireless signal is found (S620=Yes), the installer selects the CPE wireless signal at S630. For example, the installer may select an icon designating the CPE wireless signal by touching a touch screen of the wireless device or by using a cursor on a screen of the wireless device. At S635, the CPE and the wireless apparatus perform a “handshake” procedure. The handshake procedure is a form of negotiation between the CPE and the wireless apparatus to provide authentication and to ensure compatibility.

At S640, the wireless apparatus initiates a troubleshooting program that formats and presents troubleshooting information for the installer. At S645, the installer uses the troubleshooting program to request troubleshooting information, and at S650 the troubleshooting information is received by the wireless apparatus for the installer to review.

Although not required, the troubleshooting program on the wireless apparatus may be an installation program to be loaded onto a wireless computer or PDA. The wireless device may be provided with a program for presenting diagnostic information using error information from the CPE. The troubleshooting program may be provided with the CPE at the time a user buys the CPE or subscribes to a service which requires use of the CPE (e.g., a VoIP service). Accordingly, a purchaser of the CPE or the service that uses the CPE can install the troubleshooting program from a compact disc (CD) or from a website, and then use the program to obtain troubleshooting information from the CPE.

The troubleshooting information may be information related to errors that occurred during the installation process, as well as information relating to remedies for the errors. The error information may be error codes that correspond to reasons the attempt to activate the CPE has failed. Alternatively, the error information may be plain-English (or other language) text that corresponds to reasons the attempt to activate the CPE has failed.

As explained herein, the troubleshooting program can be implemented on CPE and a wireless device, such that an installer can troubleshoot activation of VoIP CPE. The VoIP CPE may be an analog terminal adapter or an IP phone. Alternatively, the wireless based troubleshooting of customer premise equipment installation can also be used to troubleshoot other devices, such as an integrated access device (IAD) or a residential gateway. Further, the present invention is not limited to VoIP CPE. Rather, the wireless based troubleshooting component of the CPE finds use in any processor-based device that is configured to provide wireless output. As explained above, the wireless based troubleshooting may find use in numerous scenarios, including CPE installation where the CPE is to be activated over a network in order to operate, and where the CPE is not equipped to provide detailed information to the installer to guide the installer in the installation and troubleshooting processes.

Although the present specification describes components and functions that may be implemented in particular embodiments with reference to particular standards and protocols, the invention is not limited to such standards and protocols. Each of the standards, protocols and languages (e.g., 802.11x protocols, Wi-Fi protocols, Bluetooth protocols and Infrared protocols) represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A method for installing customer premise equipment, the method comprising:
receiving over a wireless link, at customer premise equipment, a request for troubleshooting information; and
providing information relating to an attempt to activate the customer premise equipment over the wireless link in response to receiving the request for troubleshooting information over the wireless link.

2. The method for installing customer premise equipment of claim 1,
wherein the customer premise equipment is voice over internet protocol customer premise equipment.

3. The method for installing customer premise equipment of claim 2,
wherein the voice over internet protocol customer premise equipment is one of an analog terminal adapter, an internet protocol phone, an integrated access device and a residential gateway.

4. The method for installing customer premise equipment of claim 1,
wherein the wireless link conforms to at least one of an 802.11x, a wireless. fidelity, a Bluetooth and an infrared, wireless local area networking protocol.

5. The method for installing customer premise equipment of claim 1,
wherein the information comprises error information corresponding to a reason an attempt to activate the customer premise equipment has failed.

6. A computer readable medium for storing a computer program that provides information for installing customer premise equipment, the computer readable medium comprising:
a request receiving code segment that receives over a wireless link, at customer premise equipment, a request for troubleshooting information; and
an information providing code segment that provides information relating to an attempt to activate the customer premise equipment over the wireless link in response to receiving the request for troubleshooting information over the wireless link.

7. The computer readable medium of claim 6:
wherein the customer premise equipment is voice over internet protocol customer premise equipment.

8. The computer readable medium of claim 7,
wherein the voice over internet protocol customer premise equipment is one of an analog terminal adapter, an internet protocol phone, an integrated access device and a residential gateway.

9. The computer readable medium of claim 6,
wherein the wireless link conforms to at least one of an 802.11x, a wireless fidelity, a Bluetooth and an infrared, wireless local area networking protocol.

10. The computer readable medium of claim 6,
wherein the information comprises error information corresponding to a reason an attempt to active the customer premise equipment has failed.

11. Customer premise equipment, comprising:
a transmitter that sends information over a communications network to attempt to activate the customer premise equipment;
a wireless receiver that receives over a wireless link a request for troubleshooting information; and
a wireless transmitter that transmits information relating to the attempt to activate the customer premise equipment over the wireless link in response to receiving the request for troubleshooting information over the wireless link.

12. The customer premise equipment of claim 11,
wherein the customer premise equipment is voice over internet protocol customer premise equipment.

13. The customer premise equipment of claim 12,
wherein the voice over internet protocol customer premise equipment is one of an analog terminal adapter, an internet protocol phone, an integrated access device and a residential gateway.

14. The customer premise equipment of claim 11,
wherein the wireless link conforms to at least one of an 802.11x, a wireless fidelity, a Bluetooth and an infrared, wireless local area networking protocol.

15. The customer premise equipment of claim 11,
wherein the information comprises error information corresponding to a reason the attempt to activate the customer premise equipment has failed.

16. A wireless apparatus, comprising:
a wireless transmitter that sends over a wireless link, to customer premise equipment, a request for troubleshooting information, the troubleshooting information relating to an attempt to activate the customer premise equipment; and
a wireless receiver that receives the troubleshooting information over the wireless link.

17. The wireless apparatus of claim 16,
wherein the customer premise equipment is voice over internet protocol customer premise equipment.

18. The wireless apparatus of claim 17,
wherein the voice over internet protocol customer premise equipment is one of an analog terminal adapter, an internet protocol phone, an integrated access device and a residential gateway.

19. The wireless apparatus of claim 16,
wherein the wireless link conforms to at least one of an 802.11x, a wireless fidelity, a Bluetooth and an infrared, wireless local area networking protocol.

20. The wireless apparatus of claim 16,
wherein the information comprises error information corresponding to a reason the attempt to activate the customer premise equipment has failed.
